(19) United States
(12) Patent Application Publication
(10) Pub. No.: US 2010/0035688 A1
(43) Pub. Date: Feb. 11, 2010

(54) Electronic Game That Detects and Incorporates a User's Foot Movement

(75) Inventor: Robert Picunko, New York, NY (US)

Correspondence Address: PROSKAUER ROSE LLP, ONE INTERNATIONAL PLACE, BOSTON, MA, 02110, US

(73) Assignee: MTV Networks, New York, NY (US)

(21) Appl. No.: 12/514,261

(22) PCT Filed: Nov. 9, 2007
(86) PCT No.: PCT/US07/84297

§ 371 Date: Aug. 12, 2009

Related U.S. Application Data
(60) Provisional application No. 60/865,283, filed on Nov. 10, 2006.

(51) Int. Cl. A63F 9/24; A63F 13/00

(52) U.S. Cl. 463/39; 463/30

(57) ABSTRACT

An electronic video system incorporates the foot movements of a user into a video program. The system includes a receiver and a computer processor. The receiver is configured to wirelessly receive signals transmitted from footwear worn by a user. The signals correspond to a series of foot movements of the user. The computer processor is operatively connected to the receiver and is configured to run the video program, which utilizes the signals received by the receiver as input data. The processor processes the input data to recognize the series of foot movements of the user, and outputs video signals simulating the series of foot movements.

### CROSS REFERENCE TO RELATED APPLICATION

This application claims priority to and benefit of U.S. Provisional Patent Application Ser. No. 60/865,283 filed on Nov. 10, 2006, the entire disclosure of which is incorporated by reference herein.

### BACKGROUND OF THE INVENTION

1. Field of the Invention

The present invention generally relates to a system and a method for tracking the physical movement and position of a user and utilizing data obtained by tracking the physical movement and position in an electronic computer program. More particularly, the present invention relates to tracking the foot movement and position of a user and incorporating the data obtained by tracking the foot movement and position in an electronic computer program such as an electronic game, for example.

2. Description of the Related Art

Current gaming systems exist that offer dance pads with pressure sensors designed to receive and process data relating to the position and timing of a user's steps. Other gaming systems employ manually operated devices such as gamepads, joysticks, controllers, mice and keypads. Generally, such conventional gaming systems are limited in the complexity of the data signals measured as well as the methods in which these data signals are processed.

For example, gaming consoles, such as Dance Dance Revolution (commonly referred to as “DDR”), utilize certain techniques to interactively receive signals from the movement of a user's foot during gameplay. Specifically, DDR is a music video gaming system produced by Konami Co., Ltd., that employs a dance pad consisting of foot panels or foot switches, which include a plurality of pressure sensors designed to detect a user's steps. The use of foot switches or panels with pressure sensors is discussed in U.S. Pat. No. 6,450,886, assigned to Konami Co., Ltd., and is incorporated by reference herein. Moreover, during DDR gameplay, arrows that are synchronized to the general rhythm or beat of a chosen song appear on a screen in front of the user. The user must step on the designated panel according to the arrows, where gaming success depends on the user's ability to time and position his or her steps accordingly.

Although DDR is capable of detecting the user's steps and processing the location and timing of these steps to interact with the rhythm or beat of a song, the use of a dance pad limits the data signals being processed to the timing and position of steps made by the user. Moreover, the dance pads are large, cumbersome and relatively expensive.

Other gaming consoles, such as Nintendo's Wii® system, have taken advantage of motion-capturing components and improved speeds of wireless data transmission. Specifically, the Wii® system employs a controller that contains a combination of accelerometers and infrared detection technology, and that utilizes an array of light emitting diodes (“LEDs”) inside a so-called “Sensor Bar” to sense the position of the controller in 3D space. Accordingly, a user can play a Wii® game using physical arm movements or gestures, where data corresponding to the gestures is transmitted to a console via Bluetooth® technology.

The Wii® system, however, is limited in that the controller detects data corresponding to a physical gesture made by the user's hand and arm holding the controller, such as the gesture of a golf swing, for example, when the game pauses or prompts the user to provide input by making a gesture. The Wii® controller is not designed to detect the user's foot movement. Moreover, the processing of data transmitted by the Wii® controller generally is limited to a single gesture at a time rather than to a complex series of continuous movements involving multiple actions and steps. Further, the Wii® system processes each such single gesture such that a representation of that gesture is shown on a display screen after a significant time delay instead of in real time or close to real time during playing of the game.

### SUMMARY OF THE INVENTION

Given the foregoing, a need exists for a system that tracks the physical movement and position of a user and utilizes data obtained by tracking the physical movement and position in an electronic computer program such as an electronic game. More particularly, a need exists for a system that tracks the physical movement and position of a user's footwear, wirelessly transmits signals corresponding to the foot movement, wirelessly receives signals by a console, and executes a program that utilizes the received signal as input data.

The present invention provides a system and a method that obtains movement and position data from sensors of a user's footwear and wirelessly transmits corresponding data signals to a receiver. The receiver in turn inputs these signals as data to a processor that is configured to execute a computer program that utilizes this data Accelerometers, pressure sensors, touch sensors, or the like, are all acceptable means to detect the user's foot movement. Moreover, data transmission may be carried out by any known wireless transmission technique.

In one embodiment of the present invention, a display unit is provided to present viewable images generated by the computer program. Specifically, the computer program may utilize data signals to show movement of a video character that corresponds to movement of the user's footwear. In one aspect of the embodiment, the computer program is designed to recognize and distinguish between sensor data associated with different movements of the user's footwear. Moreover, the computer program may recognize a pattern of discrete events associated with the user's footwear movement and interpret the pattern to represent a predetermined complex or skilled movement, and cause such movement to be performed by a video character displayed on the display unit.

In another embodiment of the invention, the receiver may include a transmitter to transmit signals back to the user's footwear when certain events occur in the computer program. According to certain aspects of this embodiment, the footwear may include a force-feedback vibration system or a light system or a sound system, so that the user can be instructed on, for example, where to step or how to move as defined by the computer program.

In further embodiments of the invention, the software program may be one of the following: an aerobics video program, a martial arts video program, a dance video program, a cheerleading video program, a yoga video program, a pilates video program, a driving video program, a sports video program, a weight-reduction video program, an exercise video program, or a video game program.

In yet a further embodiment of the invention, the receiver is configured to receive signals from footwear worn by one or more other users. Accordingly, if the computer program is a video game, a dance program, or the like, two or more users may play the video game competitively or cooperatively, for example.

### BRIEF DESCRIPTION OF THE DRAWINGS

The present invention will be better understood by a study of the detailed description presented below considered in conjunction with the attached drawings, of which:

FIG. 1 shows a system diagram of an exemplary system, according to an embodiment of the present invention;

FIG. 2 shows an example of footwear, according to an embodiment of the present invention;

FIG. 3 shows an example of a receiver, according to an embodiment of the present invention;

FIG. 4 shows an example of a central system receiver that utilizes multiple reception units, according to an embodiment of the present invention; and

FIGS. 5A and 5B show flowcharts illustrating an exemplary process, according to an embodiment of the present invention.

### DETAILED DESCRIPTION OF THE INVENTION

According to an aspect of the invention, a computer system is provided, which utilizes data corresponding to foot movements of a user. The system includes a receiver configured to wirelessly receive signals transmitted from footwear worn by a user, the signals corresponding to a series of foot movements of the user; and a computer processor operatively connected to the receiver and configured to run a program that utilizes as input data the signals received by the receiver. The processor processes the input data to recognize the series of foot movements of the user, the series of foot movements including, for example, one or more of: a kick, a tap, a step, a lift, a swipe, a stomp, and a combination thereof. Additionally, the processor outputs video signals simulating the series of foot movements recognized from the input data. Optionally, the computer system may further include a display unit configured to display a video representation that simulates the series of foot movements, based on the video signals output by the processor.

In this aspect of the invention, the receiver may be configured to receive signals from at least one sensor in the footwear. The at least one sensor may include at least one of: an accelerometer, a pressure sensor, a touch sensor, a gyroscope, a magnetometer, an optical sensor, an infrared sensor, and an inertial tracker.

In this aspect of the invention, the processor includes a filter for filtering the signals received from the footwear to recognize data patterns corresponding to the series of foot movements of the user.

Optionally, the program is a video game.

Optionally, the receiver receives the signals from the footwear via Bluetooth® technology.

In this aspect of the invention, the system may further include a transmitter configured to wirelessly transmit signals to the footwear, wherein the transmitted signals include at least one of: a vibrational signal, for causing vibrations to occur in the footwear, a light signal, for causing a lighting element in the footwear to emit light, and a sound signal, for causing a sound element to emit a sound.

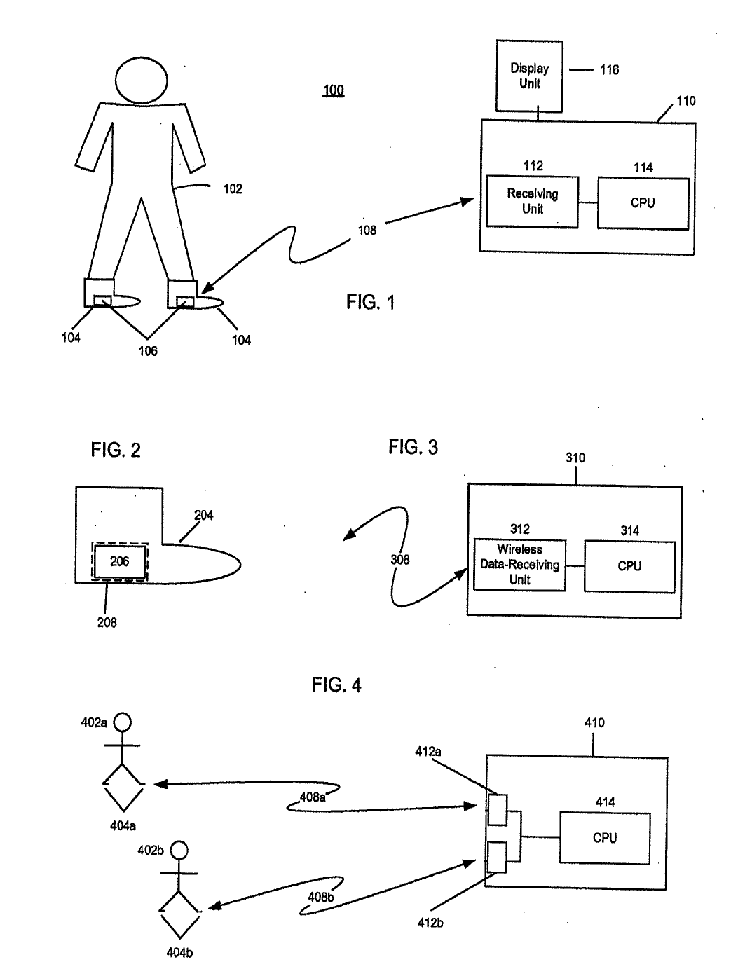

FIG. 1 schematically shows an exemplary system 100 according to an embodiment of the invention. Footwear 104, such as sneakers, shoes, sandals, boots, slippers, and the like, has incorporated therein at least one sensor 106 configured to track the foot movement and foot position of a user 102 of the footwear 104. The footwear 104 may include a pair of units, one for each foot of the user 102, with at least one sensor 106 being provided in each unit of the footwear 104. Optionally, the footwear 104 may be a single unit with at least one sensor 106 provided therein. For example, the footwear 104 may be a pair of athletic shoes, such as a pair of running shoes, jogging shoes, cross-trainers, sneakers, walking shoes, and the like.

In an aspect of the embodiment, the sensor 106 is a circuit that includes a tri-axial accelerometer. An example of such a circuit is the ZSTAR reference board manufactured by Freescale Semiconductor, Inc. Typically, a tri-axial accelerometer can sense movement in three directions (i.e., x, y, and z directions corresponding front to back, side to side, and up and down movements). When the tri-axial accelerometer is stationary, the acceleration magnitude is 1 g (9.8 m/s²) and its three-dimensional direction provides orientation and level information. When the tri-axial accelerometer moves, the acceleration it is subject to is a composite of its motion and Earth's gravity. Accordingly, the tri-axial accelerometer is able to detect movement, acceleration, and positional relationships with respect to Earth's gravitational force.

In the present aspect of the embodiment, the sensor 106 transmits wireless signals 108 with data relating to the movement and position of the user's foot. Because tri-axial accelerometers respond to rapid or slow changes in position and also are affected by gravity, when the user moves his or her foot, such as when the user lifts his or her foot while walking, acceleration data is imparted to the sensor 106. In addition to movement, because tri-axial accelerometers can detect position relative to Earth's gravitation force, the sensor 106 can detect if the footwear 104 is shifted to an inclined or declined position. Once the sensor 106 detects movement or a change in position, data signals 108 are wirelessly transmitted to a wireless data-receiving unit 112 of a system receiver 110.

According to an aspect of the embodiment, when the footwear 104 includes a pair of units with separate sensors 106, such as left and right units with respective sensors, for example, separate data signals are transmitted to the wireless data-receiving unit 112 and the relative distance between the two units may be detected.

According to another aspect of this embodiment, the sensor 106 may include one or more of measurement capabilities to detect: (1) the intensity of impact of the footwear 104 with the ground; (2) the distance the footwear 104 has traveled in a given step or movement; (3) the height the footwear 104 is off the ground; (4) the position of the footwear 104 relative to the torso of the user 102; (5) the torso rotation position relative to the surrounding environment; and (6) any change in direction of the footwear 104 or movement without the footwear 104 making contact with the ground.

In another embodiment of this invention, the sensor 106 can measure pressure data, such as pressure caused by the impact of the footwear 104 hitting a surface when the user 102 takes a step while walking. In this embodiment, pressure is measured against a surface (e.g., the ground). For example, pressure from a toe tap may be measured by a sensor positioned toward the front of the footwear 104, pressure from a heel stomp may be measured by a sensor positioned toward the back of the footwear 104, and pressure from a jump and flat-footed landing may be measured by a sensor positioned near the center of the sole of the footwear 104. When multiple sensors are used in a single unit of footwear, the relative pressure between two or more of the sensors may be used to detect the angle of the foot. Similar to the previous embodiment, when multiple sensors are used in a pair of footwear units, the distance between the footwear units can be detected.

In a further embodiment of this invention, the sensor 106 may be a touch sensor, which is a sensor that detects contact. One type of touch sensor that may be used is a simple touch sensor that detects contact by completing an electronic circuit through the closing of an electrical switch when an object is touched or contacted. Another type of touch sensor that may be used is a strain-gauge sensor, which not only detects contact with an object but may also detect the force of the contact through the amount of strain imparted to the sensor by the contact.

Other types of sensors may also be used to detect and track the motion and position of the footwear 104. These sensors include, but are not limited to: (1) gyroscopes, which measure or maintain orientation, based on the principle of conservation of angular momentum; (2) magnetometers, which measure the strength and/or direction of the magnetic field in the vicinity of the instrument; (3) inertial tracking devices, which combine accelerometers, gyroscopes, and magnetometers to accurately measure real world motion; (4) optical position sensors, which measures a position of a light spot in one or two-dimensions on a sensor surface; and (5) infrared tracking devices, which include a beacon that continuously emits infrared signals in all directions that are detected by one or more infrared receivers.

Referring back to FIG. 1, the system receiver 110 includes a central processing unit (CPU) 114. Upon receiving data signals 108 from the sensor 106, the wireless data-receiving unit 112 inputs these data signals 108 as movement and position data to the CPU 114. Applying this data, the CPU 114 executes an electronic program designed to work with data received from the footwear 104. That is, software corresponding to the program is coded to receive the movement and position data and to utilize this data while the program is in operation. The program may be, for example, a video game, an exercise video, a dance video, or the like. As will be appreciated by persons skilled in the art of computer processing, the general terms computer program or program may refer to any type of software application.

According to an aspect of the embodiment, the program utilizes movement and position data captured by the sensor 106 to show corresponding movement and position of a video character on a display unit 116, such as an animated character in a video game, for example. The display unit 116 can be a television, a computer monitor, a video display unit, or the like.

According to another aspect of the embodiment, the computer program is designed to recognize and distinguish between sensor data associated with particular dance movements. Specifically, the computer program can employ motion or gesture recognition techniques such that when a user performs distinct dance movements, for example, the video character will perform corresponding dance movements. To perform motion and gesture recognition techniques, the computer program may utilize machine-learning software. Initially, the computer program is trained with data supplied from one or more sensors measured during specific movements of a test subject or multiple test subjects. For example, for a dancing routine computer program, the test subject may be a professional dancer that performs desired dance movements. Data obtained from one or more sensors of the test subject's footwear is captured during the dance movement and imparted to the machine-learning software. The machine-learning software then may, for example, associate particular data patterns with known moves made the test subject's footwear.

In an aspect of this embodiment, the raw data outputted from the one or more sensors of the test subject's footwear is analyzed to identify discrete and physically meaningful events. For example, when a test subject makes a particular movement, the acceleration data associated with that event may be identified as a discrete event such as a thrust, freefall, snap, or the like. When such a movement is performed, data associated with the discrete event is imparted to the computer program. Similarly, when a series of foot movements (i.e., a series of discrete events) is performed, data associated with the series of foot movements is imparted to the computer program. The series of foot movements may be processed in a continuous manner to continuously impart data to the computer program.

In another aspect of the invention, the computer program may be trained to interpret a series of data patterns for a series of discrete events to correspond to a particular foot/leg movement or gesture. For example, if the computer program relates to a dance routine, and the user snaps his or her right foot backwards, then thrusts it forward and subsequently snaps it upwards, the computer program may be trained to recognize this series of data patterns as the user's desire to perform a forward flip. The computer program may be trained to classify a series of data patterns for a series of discrete events based on data obtained from foot movements made by a test subject performing the series of discrete events. As mentioned above, the machine-learning algorithm can classify certain patterns of discrete events with one or more movements or gestures, such as a forward flip, for example. That is, one or more particular patterns of foot movements may be classified to correspond to a flip or a somersault in the game, even though the user need not perform an actual flip or somersault. Accordingly, the classification scheme may correlate one or more patterns of discrete events to one or more predetermined dance movements or gestures. As will be appreciated by persons skilled in the art of machine-learning techniques, the reliability and extensiveness of the classification scheme is directly dependent on the number of test subjects utilized to train the computer program.

Referring back to FIG. 1, in operation by a user 102, data output by the sensor 106 and corresponding to a number of discrete events relating to a user's movement is input to the CPU 114. Next, the CPU 114 executes a pattern recognition algorithm to compare these discrete events with the known patterns within a classification scheme, such that the user's movement can be correlated or identified with one or more movements or gestures within the classification scheme. Once the movement or gesture is identified, the computer program causes the display unit 116 to display the corresponding foot/leg movements (e.g., dance movements) of the user.

According to an aspect of the embodiment, an advantage of processing raw data that is associated with one or more discrete events is that each event may be detected by the sensor 106 and classified by the CPU 114 with virtually no lag time, using known data-pattern recognition techniques. Accordingly, the computer program can produce a video signal simulating the user's foot movements in real-time or very close to real time.

In another aspect of this embodiment, the machine-learning algorithm can be coded such that it continues to learn after it is initially trained. In this regard, the computer program can modify its classification scheme to each individual user's unique movements and gestures.

FIG. 2 shows an example of the footwear 204 according to an embodiment of the present invention. Each unit of the footwear 204 incorporates at least one sensor 206. Preferably, the sensor 206 is securely attached to the footwear 204 and located close to the ground to maximize data accuracy and to minimize noise. In alternative embodiments (not shown), one or more sensors may be incorporated in the sole of the shoe, in the insole of the shoe, under the laces or tongue of the shoe or any combination of these locations. The use of multiple sensors per footwear unit will increase the accuracy of the data corresponding to the movement or position of the footwear 204, including the detection of the user's movement in multiple directions (e.g., forward, backward, left, right, up, down), and at different angles. When multiple sensors are incorporated, data from each sensor is discretely transmitted as individual signals, which are received by the wireless data-receiving unit 112 and processed by the CPU 114, either as individual signals or in combination with one another.

According to an aspect of the embodiment, the sensor 206 is a circuit similar to the ZSTAR reference board discussed above, which incorporates both a tri-axial accelerometer and a low-power wireless capability to transmit the movement and position data to the wireless data-receiving unit 112, as shown in FIG. 1. In an alternative embodiment, the footwear 104, 204 may incorporate both a tri-axial accelerometer and a separate transmitter and receiver unit (not shown) to communicate with the wireless data-receiving unit 112.

In an alternative embodiment, the footwear 104, 204 may include a wireless receiver to receive signals from the system 110. Moreover, the system 110 may include a transmitter to send signals to the footwear 104, 204 when an event has occurred in the computer program.

According to an aspect of the embodiment, the footwear 204 may include a force-feedback vibration system (not shown), which provides a vibrational signal to the user when an event has occurred in the software program. For example, if the software program is a game, the vibrational signal may indicate to the user that an error was made by the user, or a bonus score was obtained by the user, or the like. In another example, if the software program is an instructional dance video, the vibrational signal may indicate that the user made an off-tempo step.

According to another aspect of the embodiment, the footwear shoe includes a light system (not shown), which provides a light signal to the user to indicate the next movement to make. For example, if the program is a children's learning game, the light system indicates to a child a direction to step in, or a part of the foot to tap, or both. Light devices may be attached to different portions of the shoe to indicate to the child the next move to be made. Alternatively, instead of or in addition to the light system, a sound system (not shown) may be used.

According to yet another aspect of the embodiment, the sensor 206 is a removable circuit or system that can be easily inserted and removed from a cavity 208 provided in the footwear 204. Such a design will allow the user to quickly replace the sensor 206 if it becomes dysfunctional or exchange the sensor 206 between two or more units of footwear. Moreover, the sensor 206 itself need not be placed directly in the user's footwear, but instead may be a shoe attachment that is used with traditional footwear. For example, the shoe attachment may be an internal attachment such as an insert that is placed inside of traditional footwear, with the insert having one or more sensors incorporated therein. In another example, the shoe attachment may be an external attachment such as, for example, a boot cover worn over traditional footwear, with the boot cover having one or more sensors incorporated therein.

In an alternative embodiment, the sensor 206 may be manufactured as part of the footwear 204 and is not removable. It is understood that these embodiments can apply in the same manner where the footwear 204 uses multiple sensors or different types of sensors.

In another embodiment of the invention, shown in FIG. 3, a game system includes a system receiver 310 that wirelessly receives electronic signals 308 from one or more sensors in footwear (e.g., 204). The system receiver 310 utilizes known techniques for receiving signals wirelessly. One such technique utilizes Bluetooth® technology. As will be appreciated by persons skilled in the art of wireless signal transmission, other wireless techniques are known and may be used.

The system receiver 310 includes a wireless data-receiving unit 312 that, optionally, may include a transmitter for sending signals to the footwear 104, 204. When the wireless data-receiving unit 312 receives signals 308 from the footwear 104, 204, it inputs the data to the CPU 314, which processes the data and executes a software program.

According to an aspect of the embodiment, the system receiver 310 may be a gaming platform, such as Sony Playstation®, Microsoft Xbox®, Nintendo Gamecube®, a personal computer equipped with a transceiver for wireless communications, or the like.

According to another aspect of the embodiment, the system receiver 310 may be configured to receive multiple electronic signals 308 from footwear units worn by multiple users (not shown). That is, signals from two or more users may be received by the wireless data-receiving unit 312. The wireless data-receiving unit 312 obtains data signals from the respective users and provides this data to the CPU 314 to execute the software program in such a manner that the software program can process each user's data separately. In this way, two or more users may cooperatively or competitively play the same game, for example.

According to another embodiment of the invention, as shown in FIG. 4, multiple wireless data-receiving units 412a and 412b may be connected to a central system receiver 410 where each wireless data-receiving unit 412a and 412b receives separate data signals 408a and 408b from each footwear unit 404a and 404b of the different users 402a and 402b. The central system receiver 410 receives output signals from the multiple wireless data-receiving units 412a and 412b and provides data to the CPU 414 to execute the software program. The software program separately processes the data from the multiple wireless data-receiving units 412a and 412b such that multiple users 402a and 402b may play the same game cooperatively or competitively, for example.

According to an aspect of this embodiment, if the central system receiver 410 is a gaming platform, such as Sony Playstation® or the like, each data-receiving unit 410 can plug into the gaming console via the controller input. As will be appreciated by persons skilled in the art, the wireless communication between the footwear units 404a and 404b and the wireless data-receiving units 412a and 412b would perform in a comparable or similar manner to the wireless controllers currently marketed and sold for such gaming consoles. One example of such a wireless controller is the Logitech® Cordless Controller that is currently sold for the Sony Playstation®2 system.

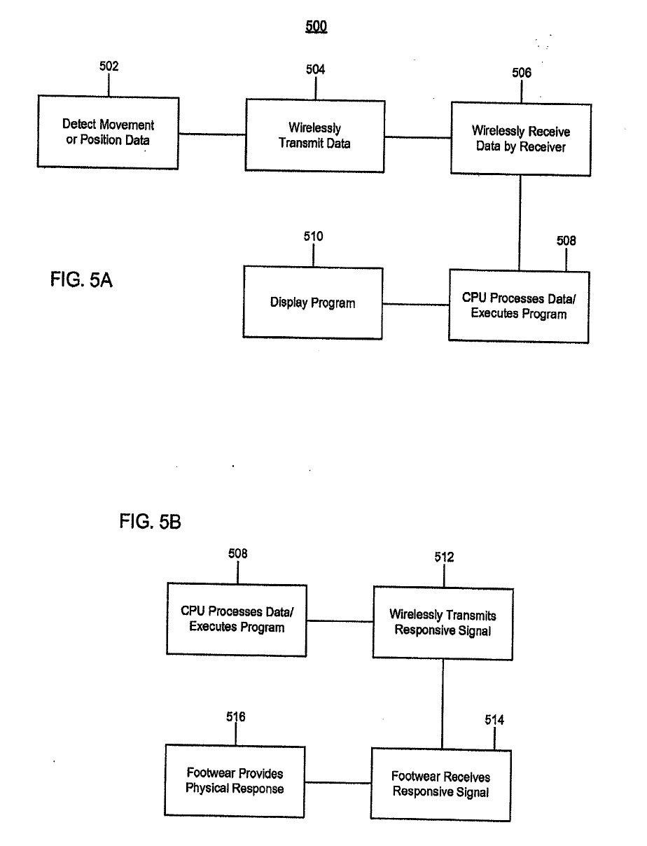

FIG. 5A shows a flowchart that illustrates the system's process 500, according to an embodiment of the present invention. Preferably, the process uses the system 100. The process 500 begins at Step 502, at which the sensor 106 detects movement and position data of the footwear 104 worn by the user 102. At Step 504, the movement or position data is wirelessly transmitted to the receiver 110 as data signals. As discussed above, the sensor 106 may be a single circuit that includes a sensor and a transmitter for wireless data transmission or the footwear 104 may employ both a sensor and separate transmitter and receiver units to communicate with the receiver 110.

At Step 506, the wireless data-receiving unit 112 receives data signals 108 corresponding to the movement and position data and inputs that data to the CPU 114. At Step 508, the CPU 114 processes the data in such a way that the data influences the results or output of the program when executed. At Step 510, a viewable moving image generated by the computer program is presented to the user on the display unit 116.

As an example of this process, if the program is a video game and the user is represented by a character in the video game, when the user makes quick walking steps, the sensor 106 in the footwear 104 worn by the user 102 detects the quick pace of the user's steps (Step 502) and transmit corresponding signals (Step 504). Data from the signal is received by the receiver (Step 506) and is input to the program (Step 508), where the program processes the data such that the video character representing the user is shown to walk quickly (Step 510).

According to an embodiment of the present invention, information obtained from one or more sensors 106 in the footwear 104 is used as input data to a controller of a video system (Step 506). Movement and position data sensed by the one or more sensors 106 is provided as the input data to the controller and is used to interact with the CPU 114 executing the software program of the video system (Step 508). That is, the CPU 114 incorporates the input data into the operation of the program, such that the video produced by the program and presented on the display unit 116 reflects the input data.

According to an aspect of the embodiment, the video system is a video game system equipped to wirelessly receive and process the information via the CPU 114 (Step 508) obtained from the one or more sensors 106 in the footwear 104. The movement and position sensed by the one or more sensors in the footwear 104 are incorporated into events that occur in the video game being played and presented on the display unit 116 (Step 510).

According to another aspect of the embodiment, the computer program is designed to recognize and distinguish between sensor data associated with specific movements (Step 508). Moreover, the CPU 114 of the video system can incorporate a pattern of data associated with discrete events to present a complex movement of a video character that occurs while the video game is being played (Step 508). For example, if the video game being played relates to a dancing routine, and the user snaps his or her right foot backwards, then thrusts it forward and subsequently snaps it upwards, the computer program may be trained to recognize this pattern of discrete events as the user's desire to perform a forward flip. As a result, the pattern of discrete events causes the video character representing the user on the display unit 114 to perform the associated forward flip.

According to yet another aspect of the embodiment, the video system is a general-purpose computer equipped to wirelessly receive and process the information obtained from the one or more sensors 106 in the footwear unit 104 (Step 506). The software program utilized or run by the video system (Step 508) may be a program related to an exercise routine, such as for yoga, aerobics, sports training, dancing, cheerleading, strength training, martial arts, jump-rope, mini-games, or the like. The program directs the activity of the player (i.e., the user) from the video displayed on a television screen or a computer screen, and measures the success of the player based on the movement and impact sensed by the one or more sensors 106 in the footwear 104. Optionally or additionally, the program may measure other quantities as well, such as the amount of calories burned by the player, for example, as estimated by the movements sensed by the one or more sensors 106.

Referring to FIG. 5B, a flowchart is shown that illustrates yet another embodiment of the present invention where the footwear 104 is capable of receiving a signal from the host computer 110. As described above, at Step 508, the CPU 114 processes the data from the sensor 106 in such a way that the data influences the results or output of the program when executed. In the present embodiment, at Step 508, when the data is being processed, if certain events occur in the software program, the CPU 114 generates responsive signals to be wirelessly transmitted at Step 512 to the footwear 104. At Step 514, the footwear 104 receives the responsive signals and processes those signals at Step 516, producing a physical response such as a vibration in the footwear 104 or an illumination of a light source attached to the footwear 104, or a sound emanating from the footwear 104.

The following are examples of applications of the present invention. Of course, the present invention is not limited to the exemplary applications discussed below, but may encompass other applications as well.

Yoga/Pilates Workout Routine: In this application, the software program directs a player or user regarding how to stand as well as where to place a foot, a leg, and/or an arm, for example. The video system reads or senses the foot placement and the foot position. The software program measures an amount of time that the player is actively participating in the workout routine, and also measures the amount of calories burned by the player. Optionally, the video system includes a memory that records the player's workout routine so that the player can watch a virtual playback of his or her workout.

Aerobics/Martial Arts Exercise Routine: In this application, the player or user provides answers to a series of questions regarding his or her level of experience and desired exercise results. The software program customizes the exercise routine for the player based on the answers. The aerobics routine may include a number of different exercises, include running in place, sit-ups, stepping patterns, stair drills, push-ups, etc. The martial arts routine may include demonstrations of moves and maneuvers for the player to repeat. Leg movements and foot movements made by the user would appear on a display unit. Optionally, the user's movement would appear via a video character on the display unit in juxtaposition with a video character performing the movements correctly.

Dancing/Cheerleading Routine: In this application, the software program teaches one or more specific types of dance, such as ballroom, ballet, hip hop, and the like. Optionally, the video system includes a memory that records the player's movements so that the player can watch a virtual playback of his or her dancing or cheerleading session. According to this option, the player also can watch a virtual playback of an original dance or cheerleading choreography.

Driving Game: In this application, the software program is video driving game that allows a player to sit in a chair and use the angle of his or her foot or feet to control acceleration and braking to simulate a driving experience via the one or more sensors in the footwear or shoe worn by the player. Optionally, the video system includes a steering device that allows the player to steer and control a virtual vehicle displayed on the television or computer screen controlled by the program.

Sports Game: In this application, the software program is a video sports game that allows the player to participate in the game. For example, the player may control and kick a video football or a video soccer ball through foot impact and movements sensed by the one or more sensors in the player's footwear. Electronic information regarding the foot impact and movements is wirelessly transmitted to the system receiver of the video system, and the program utilizes the information to show, for example, the trajectory that the video football or the video soccer ball takes based on the information obtained from the one or more sensors.

“Walk Around” Points Exercise/Game Routine: In this application, the software program is for a fitness routine that, for example, helps to fight childhood obesity and encourage kids to exercise. The one or more sensors in footwear worn by a player sense the distance walked by the player on a daily basis or on a weekly basis and, if a target distance is walked by the player during a period of time (e.g., daily, weekly, etc.), the player is allowed to advance to the next level of the program. Optionally, the program includes a game, and the player advances through different levels of the game or receives a prize based on the number of steps the players has walked in a given period of time. For example, if the player walks 3000 steps every day for seven days, then the program may enable the player to print a coupon for a prize; if the player walks 5000 steps every day for seven days, then the program may enable the player to play a particular video game by unlocking or providing access to the video game.

Children's Mini-Games: In this application, the software program is for a series of simple children's games like Simon-Sez or for activity songs that kids can play along with (e.g., Hokey Pokey). The footwear may include lights that light up when the player makes a correct move, as sensed by the one or more sensors in footwear worn by the kids.

Multiple Users: Optionally, any of these software applications may be implemented for multiple players. For example, a video sports game or driving game may allow two or more players to compete with one another. Moreover, in applications such as a dancing game, the players can practice specific dance moves with one another and also can watch a virtual playback of their dance routine.

Online Options: Optionally, the video system may have access to a communication network such as the Internet. In this way, player scores, game levels, dance choreography, etc., may be posted online and shared with others.

Other Options: Optionally, the footwear may include a processor and a memory to track and store the user's activity even when the video system is not being used. The processor includes, for example, a counting program for counting the number of steps taken by the user, as sensed by the one or more sensors in the footwear, even when the one or more sensors in the footwear are not in communication with the system receiver of the video system. The memory stores the counted number of steps and can relay that information to the video system at a later time. The speed and the distance walked by the user also may be tracked and stored by the processor and the memory.

In another option, the present invention may include a wristband with one or more sensors therein for determining arm placement and movement in an analogous manner to the one or more sensors in the footwear.

The various embodiments of the present invention described above have been presented by way of example and not limitation. It will be apparent to persons skilled in the relevant art(s) that various changes in form and detail can be made therein without departing from the spirit and scope of the present invention. Thus, the present invention should not be limited by any of the above-described exemplary embodiments, but should be defined only in accordance with the following claims and their equivalents. It is also to be understood that the steps and processes recited in the claims need not be performed in the order presented.

What is claimed is:

1. A computer system that utilizes data corresponding to foot movements of a user, comprising:
a receiver configured to wirelessly receive signals transmitted from footwear worn by a user, the signals corresponding to a series of foot movements of the user; and
a computer processor operatively connected to the receiver and configured to run a program that utilizes the signals received by the receiver as input data,
wherein the processor processes the input data to recognize the series of foot movements of the user, the series of foot movements including one or more of: a kick, a tap, a step, a lift, a swipe, a stomp, and a combination thereof, and
wherein the processor outputs video signals simulating the series of foot movements recognized from the input data.

2. The computer system of claim 1, further comprising a display unit configured to display a video representation that simulates the series of foot movements, based on the video signals output by the processor.

3. The computer system of claim 1, wherein the receiver is configured to receive signals from at least one sensor in the footwear.

4. The computer system of claim 1, wherein the program is a video game.

5. The computer system of claim 1, wherein the receiver receives the signals from the footwear via Bluetooth® technology.

6. The computer system of claim 1, wherein the receiver is configured to receive signals from left and right units of the footwear corresponding to left and right feet of the user.

7. The computer system of claim 3, wherein the at least one sensor includes at least one of: an accelerometer, a pressure sensor, a touch sensor, a gyroscope, a magnetometer, an optical sensor, an infrared sensor, and an inertial tracker.

8. The computer system of claim 1, wherein the processor includes a filter for filtering the signals received from the footwear to recognize data patterns corresponding to the series of foot movements of the user.

9. The computer system of claim 1, further comprising a transmitter configured to wirelessly transmit signals to the footwear, wherein the transmitted signals include at least one or a vibrational signal, for causing vibrations to occur in the footwear, and a light signal, for causing a lighting element in the footwear to emit light.

10. The computer system of claim 1,
wherein the receiver is configured to wirelessly receive signals transmitted from footwear of two or more users, the signals corresponding to a series of foot movements of the two or more users, and
wherein the processor processes the received signals and outputs video signals simulating the series of foot movements of the two or more users.

11. The computer system of claim 1, wherein the program is one of: an aerobics video program, a martial arts video program, a dance video program, a cheerleading video program, a yoga video program, a pilates video program, a driving video program, a sports video program, a weight-reduction video program, an exercise video program, and a video game program.

12. A computer-implemented method for utilizing data corresponding to foot movements of a user, comprising:
wirelessly receiving signals transmitted from footwear worn by a user, the signals corresponding to a series of foot movements of the user;
executing a computer program that utilizes the signals received by the receiver as input data;
processing the input data to recognize the series of foot movements of the user, the series of foot movements including one or more of: a kick, a tap, a step, a lift, a swipe, a stomp, and a combination thereof; and
outputting video signals simulating the series of foot movements recognized from the input data.

13. The method of claim 12, further comprising displaying a video representation that simulates the series of foot movements, based on the outputted video signals.

14. The method of claim 12, further comprising:
obtaining a plurality of training data corresponding to a foot movement; and
processing the plurality of training data to determine a data pattern representative of the foot movement,
wherein the processing of the input data to recognize the series of foot movements of the user includes filtering the input data to recognize the data pattern representative of the foot movement.

15. The method of claim 12, wherein the processing of the input data includes filtering the input data to recognize data patterns corresponding to the series of foot movements of the user.

16. Footwear for a video-game system, comprising:
a housing unit configured to be attached to a foot of a user; and
a sensor assembly attached to the housing,
wherein the sensor assembly includes:
at least one sensor for sensing a series of foot movements of the user, and
a transmitter for wirelessly transmitting signals to a video-game system, the signals corresponding to the series of foot movements of the user.

17. The footwear of claim 16, wherein the at least one sensor includes at least one of: an accelerometer, a pressure sensor, a touch sensor; a gyroscope; a magnetometer; an optical sensor; an infrared sensor; and an inertial tracker.

18. The footwear of claim 16, wherein the housing unit is a shoe, and wherein the sensor assembly is incorporated in the shoe.

19. The footwear of claim 16, wherein the housing unit is a shoe, and wherein the sensor assembly is removably attachable to the shoe.

20. The footwear of claim 16, wherein the housing unit is configured to be attachable to a shoe or to the foot of the user.

21. The footwear of claim 16, further comprising a receiver for receiving signals from the video-game system.

22. The footwear of claim 21, further comprising a lighting element, wherein the signals received from the video-game system cause the lighting element to emit light.

23. The footwear of claim 21, further comprising a vibration element, wherein the signals received from the video-game system cause the vibration element to vibrate.

24. The footwear of claim 21, further comprising a sound element, wherein the signals received from the video-game system cause the sound element to emit a sound.
